(19) United States
(12) Patent Application Publication
(10) Pub. No.: US 2014/0210992 A1
(43) Pub. Date: Jul. 31, 2014

(54) INFRARED THERMOGRAPHY WITH LASER

(71) Applicant: United Technologies Corporation, Hartford, CT (US)

(72) Inventor: Yan Zhang, Vernon, CT (US)

(73) Assignee: United Technologies Corporation, Hartford, CT (US)

(21) Appl. No.: 14/169,820

(22) Filed: Jan. 31, 2014

Related U.S. Application Data
(60) Provisional application No. 61/759,115, filed on Jan. 31, 2013.

(51) Int. Cl. H04N 7/18; G01J 5/10

(52) U.S. Cl. CPC H04N 7/18; G01J 5/10
USPC 348/86

(57) ABSTRACT

A thermography system includes a laser adapted to emit energy. An emitter attached to a mount, optically coupled to the laser, the emitter adapted to radiate the energy in substantially a first direction and an infrared camera attached to the mount with a field of view intersecting a portion of the first direction.

This application claims priority to U.S. Patent Appln. No. 61/759,115 filed Jan. 31, 2013.

### BACKGROUND

The present disclosure relates to infrared thermography.

Infrared thermography (IRT), thermal imaging, and thermal video are examples of infrared imaging. Thermal imaging cameras detect radiation in the infrared range of the electromagnetic spectrum (roughly 900-14,000 nanometers or 0.9-14 μm) and produce images of that radiation, called thermograms.

Infrared (IR) thermography is used in a number of applications. In one example, IR thermography provides a versatile non-destructive testing (NDT) technique that uses temporal measurements of heat transference through a workpiece to provide information of the structure and integrity of the workpiece. The terms Nondestructive examination (NDE), Nondestructive inspection (NDI), and Nondestructive evaluation (NDE) are also commonly used to describe technology that provides information about a workpiece without causing the destruction of the workpiece.

Infrared thermography NDT typically utilizes a flash lamp and a camera to measure potentially hidden defects in the workpiece. The flash lamp may be relatively bulky and may have relatively low lateral resolution.

### SUMMARY

A thermography system according to one disclosed non-limiting embodiment of the present disclosure includes a laser adapted to emit energy. An emitter is attached to the mount, optically coupled to the laser, the emitter adapted to radiate the energy in substantially a first direction. An infrared camera attached to the mount with a field of view intersecting a portion of the first direction.

A further embodiment of the present disclosure includes, wherein the mount is U-shaped.

A further embodiment of any of the foregoing embodiments of the present disclosure includes, wherein the emitter is opposite the infrared camera.

A further embodiment of any of the foregoing embodiments of the present disclosure includes, wherein the mount orients the first direction to intersect with a lens of the infrared camera.

A further embodiment of any of the foregoing embodiments of the present disclosure includes, wherein the emitter is coincident to the infrared camera.

A further embodiment of any of the foregoing embodiments of the present disclosure includes, wherein a workpiece is located within the field of view of the camera and intersects the first direction.

A further embodiment of any of the foregoing embodiments of the present disclosure includes, wherein the infrared camera observes a transmitted heat signature from the emitter.

A further embodiment of any of the foregoing embodiments of the present disclosure includes, wherein the infrared camera observes a heat signature of the workpiece.

A further embodiment of any of the foregoing embodiments of the present disclosure includes, wherein the infrared camera observes a heat signature induced by said energy from the emitter.

A further embodiment of any of the foregoing embodiments of the present disclosure includes, wherein a workpiece is located on one side of the emitter and the infrared camera.

A further embodiment of any of the foregoing embodiments of the present disclosure includes, wherein the emitter includes a fiber from the laser and a lens.

An infrared (IR) thermography method according to another disclosed non-limiting embodiment of the present disclosure includes inducing a thermal load on a workpiece with an emitter attached to a mount, the emitter receiving energy from a laser; and directing a field of view of an infrared camera attached to the mount toward the workpiece.

A further embodiment of any of the foregoing embodiments of the present disclosure includes observing a heat signature induced by said energy with the infrared camera.

A further embodiment of any of the foregoing embodiments of the present disclosure includes observing a heat signature with the infrared camera.

A further embodiment of any of the foregoing embodiments of the present disclosure includes collocating the laser with the infrared camera.

A further embodiment of any of the foregoing embodiments of the present disclosure includes mounting the laser opposite the infrared camera.

An infrared (IR) thermography method according to another disclosed non-limiting embodiment of the present disclosure includes inducing a thermal load on a workpiece with an emitter attached to a mount to radiate energy from a laser in a first direction; and directing a field of view of an infrared camera attached to the mount to intersect a portion of the first direction.

A further embodiment of any of the foregoing embodiments of the present disclosure includes locating the workpiece between the emitter and the infrared camera on a U-shaped mount.

A further embodiment of any of the foregoing embodiments of the present disclosure includes, wherein the workpiece is an aerospace component.

A further embodiment of any of the foregoing embodiments of the present disclosure includes co-locating the laser and the infrared camera on the mount.

The foregoing features and elements may be combined in various combinations without exclusivity, unless expressly indicated otherwise. These features and elements as well as the operation of the invention will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic block diagram of a thermography system according to one disclosed non-limiting embodiment; and

FIG. 2 is a schematic block diagram of a thermography system according to one disclosed non-limiting embodiment.

### DETAILED DESCRIPTION

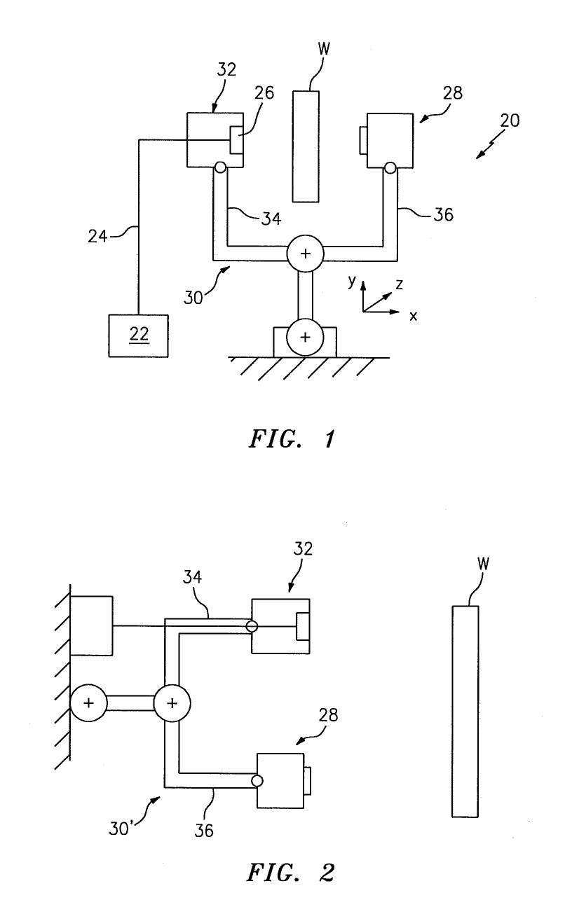

FIG. 1 schematically illustrates a thermography system 20. The system 20 generally includes a source 22, a fiber 24, a lens 26, an infrared camera 28 and a mount 30. The source 22 may be a laser provides intense illumination through, for example, the fiber 24 then the lens 26 to illuminate an area upon a workpiece W. It should be appreciated that the lens 26 may be selected to cover a tightly focused area of the workpiece W or the entirety thereof.

The workpiece W is typically of a material with a relatively slow thermal conductivity. The workpiece W may be, for example, a non-metal component such as a ceramic matrix composite (CMC), polymer matrix composites (PMC) a metallic alloy such as a Titanium alloy as well as a thermal barrier coating on a metallic (relatively high thermal conductivity) substrate.

The source 22 is more efficient in electricity conversion to photons compared to a traditional flash lamp. The source 22 facilitates the direct intense illumination of the workpiece W. Alternatively, the source 22 may be utilized to scan the laser beam over the workpiece W point by point to heat up the workpiece W. The infrared camera 28 then measures the localized heating of the workpiece W. The recorded measurements from the infrared camera 28 provide information regarding the characteristics of the workpiece W.

The infrared camera 28 may in one example be a charge-coupled device (CCD) sensor or complementary metal-oxide-semiconductor (CMOS) sensor. In another aspect, the infrared camera 28 may have a sensor that is cooled or uncooled. In one aspect, the infrared camera 28 is a video camera to record and store successive thermal images (frames) of the workpiece W surface after heating. In another aspect, an image capture and storage system captures successive measurements from the infrared camera 28 and stores the measurements within a computer system, and optical or other storage or memory architecture.

As defined herein video is a sequence of images that are either fully complete, i.e. having all pixel elements measured by the camera at a certain capture point or capture window from e.g. a frame grabber or interrelated images, e.g. to capture interlaced images from standard ‘video’. Each image is composed of a fixed number of pixels. In this context, a pixel is a small picture element in an image array or frame which corresponds to a rectangular area, called a “resolution element”, on the surface of the object, i.e. the workpiece W, being imaged. The intensity of the corresponding pixel element is a function of the temperature of the corresponding resolution element on the surface of the workpiece W. Thus, discrete temperatures and temperature changing rate at each on the surface of the workpiece W can be analyzed. Similarly changes in temperature overtime are determinable by changes in pixel intensity over time (i.e. between successive images of the same picture element. The source 22 induces the temperature change on the workpiece W. The stored video images are used to determine the contrast of each pixel in an image frame by subtracting the mean pixel intensity for a particular image frame captured a specific point in time from the individual pixel intensity within the same image frame.

The mount 30 in one disclosed non-limiting embodiment is generally U-shaped. The mount 30 positions the fiber 24 and the lens 26 as an emitter 32 to a first arm 34 and the infrared camera 28 to a second arm 36. That is, the emitter 32 is directed toward the infrared camera 28 on the mount 30 such that the workpiece W is located therebetween to observe the transmitted heat signature. The arm length of the mount 30 may be adjustable to facilitate sweeping along the workpiece W. The mount 30 may alternatively be located on an XYZ stage to control a position thereof.

With reference to FIG. 2, in another disclosed non-limiting embodiment, the mount 30′ is also U-shaped with the emitter 32 and the infrared camera 28 are arranged on one side of the workpiece W to observe a heat signature induced on the same portion of the part. In one embodiment, shown in FIG. 2, the emitter 32 and the infrared camera 28 are physically separated. In another embodiment, not shown, the emitter 32 and the infrared camera 28 are co-located.

The center of vision of the infrared camera 28 is oriented relative to the laser spot on the workpiece W in an at least Mode 1 and Mode 2 operation. In Mode 1, the source 22 is utilized to illuminate/heat a large patch area on the workpiece W with the center of vision of the infrared camera 28 on the center of the patch. Mode 2 may operate as a scanning scheme.

Integration of the emitter 32 facilitates non-destructive testing (NDT) within a limited space to readily benefit repair and service in a forward operating area such as on-wing inspection in a shipboard-environment. The emitter 32 and the infrared camera 28 may alternatively be utilized separated from the mount 30. The thermography system 20 permits usage of a fiber to deliver a laser beam to heat the workpiece W and a U-shape mount 30 to facilitate hard to access areas. One particular application may be in a shipboard environment such as that of an aircraft carrier, where the space is extremely limited and this NDE technology is beneficial to test the structural integrity of ceramic components in an aircraft.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that relative positional terms such as “forward,” “aft,” “upper,” “lower,” “above,” “below,” and the like are with reference to the normal operational attitude of the vehicle and should not be considered otherwise limiting.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A thermography system comprising:
a mount;
a laser adapted to emit energy;
an emitter attached to said mount, optically coupled to said laser, said emitter adapted to radiate said energy in substantially a first direction; and,
an infrared camera attached to said mount with a field of view intersecting a portion of said first direction.

2. The thermography system as recited in claim 1, wherein said mount is U-shaped.

3. The thermography system as recited in claim 1, wherein said emitter is opposite said infrared camera.

4. The thermography system as recited in claim 1, wherein said mount orients said first direction to intersect with a lens of said infrared camera.

5. The thermography system as recited in claim 1, wherein said emitter is coincident to said infrared camera.

6. The thermography system as recited in claim 1, wherein a workpiece is located within said field of view of said camera and intersects said first direction.

7. The thermography system as recited in claim 6, wherein said infrared camera observes a transmitted heat signature from said emitter.

8. The thermography system as recited in claim 6, wherein said infrared camera observes a heat signature of said workpiece.

9. The thermography system as recited in claim 6, wherein said infrared camera observes a heat signature induced by said energy.

10. The thermography system as recited in claim 1, wherein a workpiece is located on one side of said emitter and said infrared camera.

11. The thermography system as recited in claim 1, wherein said emitter includes a fiber from said laser and a lens.

12. An infrared (IR) thermography method comprising:
inducing a thermal load on a workpiece with an emitter attached to a mount, the emitter receiving energy from a laser; and
directing a field of view of an infrared camera attached to the mount toward the workpiece.

13. The method as recited in claim 12, further comprising:
observing a heat signature induced by said energy with the infrared camera.

14. The method as recited in claim 12, further comprising:
observing a heat signature with the infrared camera.

15. The method as recited in claim 12, further comprising:
collocating the laser with the infrared camera.

16. The method as recited in claim 12, further comprising:
mounting the laser opposite the infrared camera.

17. An infrared (IR) thermography method comprising:
inducing a thermal load on a workpiece with an emitter attached to a mount to radiate energy from a laser in a first direction; and
directing a field of view of an infrared camera attached to the mount to intersect a portion of the first direction.

18. The method as recited in claim 17, further comprising:
locating the workpiece between the emitter and the infrared camera on a U-shaped mount.

19. The method as recited in claim 17, wherein the workpiece is an aerospace component.

20. The method as recited in claim 10, further comprising:
co-locating the laser and the infrared camera on the mount.
